(19) United States
(12) Patent Application Publication
(10) Pub. No.: US 2013/0151381 A1
(43) Pub. Date: Jun. 13, 2013

(54) MULTIPLE-RETAILER INTERNET SALES SYSTEM AND METHOD

(71) Applicant: Gregory W. Klein, Pittsburgh, PA (US)

(72) Inventor: Gregory W. Klein, Pittsburgh, PA (US)

(21) Appl. No.: 13/646,209

(22) Filed: Oct. 5, 2012

Related U.S. Application Data
(60) Provisional application No. 61/564,088, filed on Dec. 8, 2011.

(51) Int. Cl. G06Q 30/06

(52) U.S. Cl. CPC G06Q 30/0641
USPC 705/27.1

(57) ABSTRACT

Systems and methods that facilitate sales of products are discussed herein. Such a system can include an inventory integration component that can receive information related to each of one or more inventories associated with one or more retailers and can create a master inventory comprising the information related to each of the one or more inventories, and a sales distribution component that can determine, from the one or more retailers, an appropriate retailer for each of the one or more products upon selection of the one or more products by a customer.

### CROSS-REFERENCE TO RELATED APPLICATIONS

This application is related to U.S. Provisional Patent application Ser. No. 61/564,088 entitled “MULTIPLE-RETAILER INTERNET SALES SYSTEM AND METHOD” and filed Dec. 8, 2011 and claims the benefit thereof. The entirety of the above-noted application is incorporated by reference herein.

### BACKGROUND

An overwhelming amount of business is transacted through the Internet, and a business not having an Internet presence or storefront can cause missed opportunities, wherein the business loses the revenue of a potential sale, and potential customers may be unable to find products they otherwise could, or unable to find them at the best prices. However, for smaller businesses, the cost of creating, promoting, and maintaining an Internet storefront can be a proportionally more significant expense than for larger businesses.

Additionally, it can be inefficient for web-based stores or physical locations with a web presence to maintain a comprehensive local inventory of all possible products that distant web consumers desire. Inventory limitations (e.g., a limited number of items or varieties in stock) can cost a smaller business potential revenue not just in terms of the initial sale if a desired product is not in stock, but also potential repeat business. Even if a business has the means to establish massive inventories, tying up liquidity and warehousing products in a discrete location can be inefficient, as web-based consumers order from around the globe, and warehousing products can actually move goods farther away from an end consumer.

For customers, the explosion of web commerce has yielded many benefits, but has also increased the complexity of making savvy decisions. There is an increased time commitment to shop the many non-local or smaller vendors (e.g., finding and browsing to different web pages, inputting billing information, etc.), which may disincentive shopping with some web stores, even if the pricing, products, service, etc. would be equal to or superior to that found elsewhere. Further, limited feedback or feedback from disparate sources and an aversion to unknown online sellers can discourage consumers from giving business to new vendors.

Accordingly, there is a need to streamline processes related to online commerce to permit a variety of stores with a web-presence the ability to compete and collaborate. Further, it is desirable to develop and implement systems and methods that help consumers confidently shop across a wide variety of online retailers.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that facilitates selling one or more products. In some aspects, the system can include an inventory integration component that can receive information related one or more inventories associated with one or more retailers and can create a master inventory comprising the information related to each of the one or more inventories. In additional aspects, the system can also include a customer interface component that can present data regarding the one or more products for sale to a customer, wherein the customer information component obtains the data from the master inventory. Additionally, the system can include a sales distribution component that can determine, from the one or more retailers, an appropriate retailer for each of the one or more products upon selection of the one or more products by the customer.

Another aspect of the subject innovation can comprise a method that facilitates selling one or more products. Some aspects of the method can include the act of receiving data associated with one or more inventories of one or more retailers. Additionally, there can be the acts of integrating the data into a master inventory that associates the one or more inventories with the one or more retailers and presenting the one or more products to a customer based at least in part on information stored in the master inventory. Further, the method can include the act of determining an appropriate retailer for each product of the one or more products.

Other aspects, related to both competition and collaboration for the benefits of consumers and retailers, will be apparent in view of the disclosures herein.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example embodiment of a system that facilitates sale of one or more products in accordance with aspects of the subject innovation.

FIG. 2 illustrates an example implementation of an inventory integration component in aspects of the subject innovation.

FIG. 3 illustrates an example implementation of a sales distribution component in accordance with aspects of the subject innovation.

FIG. 4 illustrates a flowchart of a method of selling one or more products in accordance with aspects of the subject innovation.

FIG. 5 illustrates a block diagram of a computer operable to execute the disclosed architecture.

FIG. 6 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

As used herein, the term “retailer” can be used to refer to companies, individuals, and other entities providing inventory information in conjunctions with systems or methods described herein. In some embodiments, a “retailer” need not be engaged in retail sales, or include retail locations. Different retailers are viewed as independent business entities. In this regard, different retailers, for the instant purposes, are viewed as having no common owner, having no common franchise agreement, and so forth. While a single retailer may own multiple locations that can leverage aspects described herein, this distinction is drawn to ensure competitive and collaborative aspects from unrelated entities are appreciated. The fact that entities are unrelated or unaffiliated in a business sense does not mean they are completely distinct, as they can still operate within the same niches, use the same distributors, share customers, and have other common attributes. Generally, different retailers do not have a standing agreement to share profits or actively share business, but systems and methods herein can facilitate temporary or ongoing agreements to this effect. At times, other terms related to retailers may be used, such as business, vendor or seller. It is intended that synonymous terms not imply any conflicting concepts unless expressly stated, and that similar language will be understood in the context used.

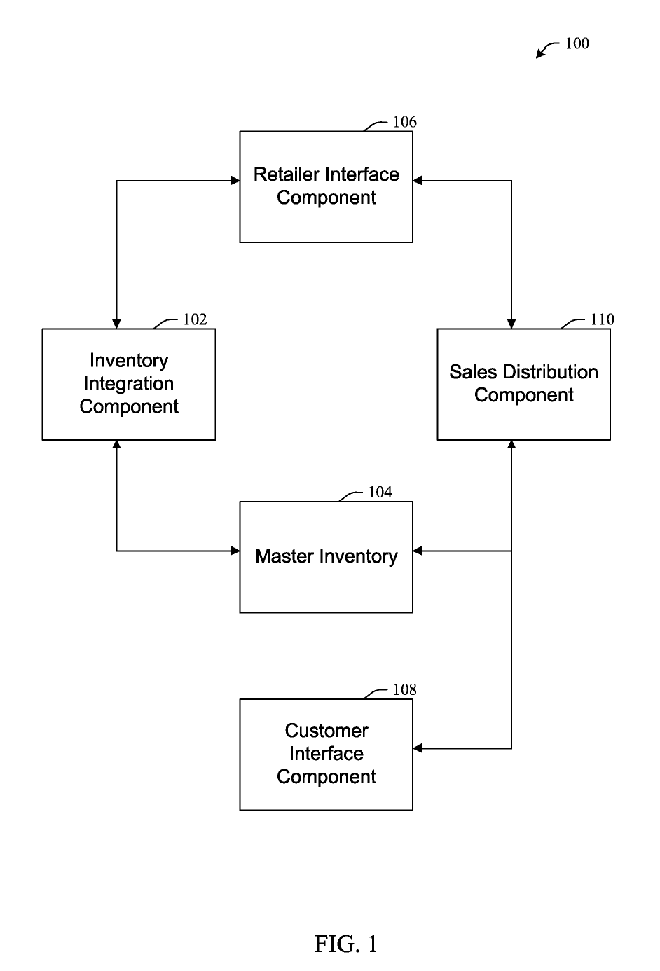

Referring initially to the drawings, FIG. 1 illustrates an example embodiment of a system 100 that facilitates sales of one or more products in accordance with aspects of the subject innovation. System 100 can include an inventory integration component 102 that can receive information associated with an inventory from each of one or more retailers and integrate the information regarding the inventories into a master inventory 104. In some aspects, data regarding the one or more inventories can be provided by the one or more retailers through a retailer interface component 106. A customer interface component (e.g., retail website, etc.) 108 can allow for customer interaction with a store (e.g., via the Internet, etc.) associated with the master inventory 104. When a customer purchases an item through the customer interface component 108, a sales distribution component 110 can query the master inventory 104 to determine an appropriate retailer to ship the item to the customer. The sales distribution component can contact the appropriate retailer via the retailer interface component 106.

Inventory integration component 102 can receive a variety of information related to inventories. Inventories can include one or more groups or types of products. In some embodiments, inventory information can be focused toward the retailer. For example, the retailer's product costs, including shipping and warehousing, can be logged by product, group, enterprise, or other techniques. Employee time associated with managing or processing the product can also be tracked, as can locations, sales figures, nearby inventories, and so forth. In some embodiments, product information related By providing enriched details to retailers, they can make sound business decisions and more carefully manage their inventory either independently or in collaboration with other retailers selling the same or competing products.

Inventory information can also be stored for consumer benefit, allowing higher resolution information to be directed to customer interface component 108. In one example, the location of various inventory items, as well as the actual availability, speed, reliability and cost of various shipping options from those locations (as opposed to shipper-estimated) can be stored. In some embodiments, different types of retailer information can be imported and standardized for consumer benefit. In one example, many online retailers permit shoppers to leave product feedback information. This information can be imported and standardized to allow users to receive more feedback than is available from any one source. Similarly, retailer ratings from locations like the Better Business Bureau™, Google™, and various industry-specific sites can lend credibility to a retailer's reputation, but require a consumer to seek this information from a variety of disparate sources. Accordingly, the inventory integration component can collect information about the retailers as well, including information provisioned from a variety of known network sources or disparate sources to which the retailer directs. Thus, in addition to information such as product, variant, location and quantity, enriched data can be provided to consumers that go beyond a basic inventory can be provided about one or more products and retailers selling such.

Master inventory 104 can accept information from the inventory integration component. Master inventory can include, but is not limited to, networked data storage. Master inventory 104 can include one or more databases that can be created and formatted using different standards or techniques. In some embodiments, retailer inventories are accepted in a variety of formats (e.g. Excel™, Access™, character-delimited tables, other proprietary types) via inventory integration component 102. In some embodiments, master inventory 104 aggregates individual retailer inventories and additional information in the format provided, and provides functionality to search and sort without converting data. In other embodiments, inventory integration component 102, master inventory 104, retailer interface component 106, another component, or combinations thereof converts all data to a standard format used for all retailers in master inventory 104.

Retailer interface component 106 can include a variety of functions for both collecting information from a retailer and providing information to a retailer. Retailer interface component can receive information related to a retailer's inventory or inventories. Information can include product make, model and variant, the quantities and location of products, tracking and metadata used for universal identification, cost and pricing information (including both a price offered to consumers or businesses, and the costs associated with acquiring and managing the inventory), and others.

Retailer interface component 106 can be a web interface, a local software module, a software module executed remotely, or others. In some embodiments, web interface component 106 can interface with proprietary inventory or retail systems (e.g., cash registers) to automatically locate, read, store and update information related to master inventory 104. In some embodiments, retailer interface component 106 can be implemented a variety of ways. For example, a software module can be installed locally on a desktop computer at an office location, a mobile app can be installed on a cellular device or tablet, and a web interface can be available for use on computing devices unable to install the application. In some embodiments, various image recognition, text recognition, speech recognition, conversion and importing techniques can be employed to facilitate integration of data provided via retailer interface component. For example, spreadsheet files can be converted to a common format, product images can be identified and associated, image-based text can be recognized and imported, and in-store or mobile activity (e.g., speech) can be utilized to effect actions via retailer interface component 106. In some embodiments, similar products (e.g. two different ski pole models) or variants of the same product (e.g., different color, pattern, or size of the same ski pole model) can be recognized and grouped. A user of retailer interface component 106 can also direct retailer interface component 106 to additional information sources (e.g., their own website, other online reviews, shipping information, customer databases) to read and import. In some embodiments, a plurality of links is associated with a retailer inventory. In alternative embodiments, the content from a plurality of links itself is associated with a retailer inventory. In some embodiments, standard or custom inputs (e.g., radio options, text box, drop-down menus, file selection boxes, upload interfaces) can be employed to allow retailer interaction with respect to collecting and/or accessing information via retailer interface component 106.

A variety of information can also be provided to the retailer via retailer interface component 106 in some embodiments. For example, retailer interface component 106 can allow a user to view enterprise wide inventory as provided to the system, from any device capable of functioning with retailer component 106. For example, an owner on vacation abroad can use a mobile device to access retailer interface component 106 and check on enterprise-wide inventories between multiple locations remotely. Internal or public sales trends, market information, and financials associated with the inventories can be analyzed and presented. In some embodiments where master inventory 104 is accessible to all participating retailers, a retailer can view aggregated and/or blind statistics and trends relating to master inventory 104, to detect larger trends and determine local, regional, or total retail inventories of particular items. In some embodiments, different retailers can agree to higher levels of collaboration, and master inventory 104 is full accessible to one or more retailers, allowing detailed information associated with particular retailers or locations to be discovered by other retailers via retailer interface component 106.

In some embodiments, retailer interface component can include security to prevent tampering and require authentication before viewing or altering information accessible via retailer interface component 106. In some embodiments, retailer interface component 106 can leverage native security procedures and protocols to identify a user before permitting use. In other embodiments, retailer interface component 106 can be secured, locally or remotely, with a unique authentication dedicated solely to the aspects described herein.

In some embodiments, retailer interface component 106 can also include an inter-retailer communications component. A retailer can send one or more public or private messages to another retailer or groups of retailers, and receive and reply to the same via retailer interface component 106.

Customer interface component 108 allows customers to shop via master inventory 104. Consumers are given a single-point solution to search through a variety of retailers. While consumers can be aware of a local shop or major online retailer, master inventory 104 permits them to search additional or previously unknown inventories to find the exact item desired, as well as locate a variety of prices and other options, in various geographic locations.

Customer interface component 108 can include, for example, a search function, display areas for product information, and various selections or inputs supporting filtering, sorting, and other features that increase the convenience and usability of online shopping platforms. Security features such as password protection can be implemented, and customer interface component 108 can additionally employ local and network security and operate utilizing secure protocols to facilitate handling of sensitive information associated with electronic commerce (e.g., credit or bank information, identifying information such as addresses). In some embodiments, customer and/or payment information can be stored. Variants of such embodiments can employ encryption and various other data security techniques to secure customer and/or payment information.

Customer interface component 108 can present users with a rich shopping experience including a variety of information. Users can find a particular item or class of items and determine if and where the item(s) are in stock, as well as view shipping options, times and costs. In some embodiments, a desired number or combination of items is not available at a single location, permitting aggregation of an order from master inventory 104. The user can place a single order for multiple items from different retailers, but the disparate sources can be masked, giving the user the impression a single order is being fulfilled at once. In alternative embodiments, the user can select a particular retailer based on location, price, reputation, and other factors. Customer interface component 108 can display these and other aspects related to one or more retailers, their products, alternatives or competitors, transaction information, and other information or entities.

Sales distribution component 110 can interact with other components to facilitate transactions between retailers and customers, as well as maintain master inventory and other databases. A user can place an order through customer interface component 108. In embodiments where the user is not specifically selecting a particular retailer and is generally just seeking a particular product at or below a certain price, or desires delivery of the product within a certain window, sales distribution component can evaluate inventories and determine the optimal means of satisfying the order. For example, if a user wants the best price on ski equipment, sales distribution component 110 can evaluate the lowest total price to the consumer by comparing shipping costs from an overseas store's inventory to the price premium of a nearby domestic store. In another example, a customer wants an item as fast as possible but does not wish to pay for overnight shipping. Sales distribution component 110 can evaluate nearby inventories containing the item, and calculate shipping times at low expense, including not only standard shipper estimates, but also anecdotal or statistical information associated with customer or retailer information relating to fulfillment times. In an embodiment, sales distribution component can identify information indicating a retailer fulfills orders two days later than a peer retailer for similar orders shipped similar distances. However, the slower retailer may offer a price discount compared to the faster retailer. Sales distribution component can use this information to automatically select retailers or inventories with which to place a particular customer's order.

In an embodiment, sales distribution component can facilitate replenishing an inventory. For example, if a retailer's inventory in a certain item is low after a sale, sales distribution component 110 can notify the retailer, or automatically place an order to replenish the inventory. In an embodiment, sales distribution component 110 can map trends, specific to the retailer or with respect to all retailers associated with master inventory 104 (or using other data sources), to anticipate demand or estimate when resupply orders should be placed.

After an order is complete, sales distribution component 110 can report sales information to master inventory 104, as well as other sources permitting one or both of retailer interface component 106 and customer interface component 108 to view some or all details relating to the order. In some embodiments, sales distribution component 110 updates information upon receipt of an order before payment is processed. In other embodiments, sales distribution component 110 does not begin disseminating information throughout system 100 until payment is processed. In still other embodiments, sales distribution component 110 employs a real-time approach where order process, payment process, and item location are carefully monitored continuously to provide the most current information to retailers and customers on stock amounts, availability and order status. In some embodiments, sales distribution component 110 can facilitate order tracking upon purchase either via system 100 or by leveraging or reporting-out to third party tracking processes.

In some embodiments, information about retailers and inventories can be supplemented by information about customers. One or more customer's demographics, purchase history, and other marketing information can be stored. In some embodiments, customer information is aggregated, and individual records are made blind for purposes of privacy. In other embodiments, more specific, identifiable customer information can be provided to one or more retailers. In some such embodiments, only retailers with which a customer has done business can access identifiable customer information. In other such embodiments, all retailers with products that the user has purchased or is seeking to purchase can access customer information. In still other embodiments, all retailers with access to the master database or subsets of its information can see some or all identifiable customer information. Other techniques will be appreciated by those skilled in the art in view of the disclosures herein.

In some embodiments, the scope of system 100 can be focused in a niche market. Retailer interface component 106 can limit retailers to submit particular products, classes of products, or related products to master inventory 104. Customer interface component 108 can search master inventory 104 which is dedicated to a particular niche. In one embodiment, system 100 can be a system solely for skiing equipment. Various retailers around the world have relatively small inventories of equipment dedicated to skiing, such that they cannot reliably and timely fulfill orders nationally or internationally online. However, some retailers that do have sufficient logistical bandwidth to support online orders lack sufficient reputation and profile to take full advantage of their web presence. In this case, participation in system 100 benefits all parties to transactions. Master inventory 104 allows consumers to search a larger group of retailers faster, particularly targeting the type of products they seek, thus avoiding the need for extensive sorting or ignoring irrelevant results. Retailers participating in system 100 can sell in accordance with their capabilities, and need not maintain large inventories or market extensively to complete sales in previously unreachable markets.

In view of these disclosures, various schemes for collaboration and competition can be appreciated. With respect to collaboration, in one embodiment, both retailers and customers can benefit from “group buys.” For example, an upstream distributor with access to system 100 can send a communication to retailers, customers, or both, notifying the entities of a reduced rate available if purchased in bulk. Alternatively, retailers can coordinate among peers to have one retailer execute a purchase on all their behalf. In some embodiments, a volume shipment can be delivered to a single retailer or distribution point, but entered into master database 104 in smaller elements, allowing retailers owning a portion of a group buy to have their inventory reflect these products, even if they are never in physical contact with the products.

Customers can also be notified of group buy opportunities via customer interface component 108, permitting a single retailer or group of retailers to offer a bulk discount assuming a certain number of units are sold within a particular time frame.

Retailers can also collaborate by “sharing” inventory, even though it is associated with a specific retailer. Retailers can agree, in advance or on-the-fly (e.g., as orders are received) to fill orders for others from their own stocks. In this way, customers can avoid waits for back-ordered products, or locate quantities or variants of discontinued products without searching beyond their known and trusted vendors. For example, a customer may wish to order skis for their family. The size and color required for a daughter can be different than that for a son, and a mother, an experienced skier, can be partial to a recently-discontinued make of skis. Unfortunately, no single retailer possesses the stock required to complete the transaction, as smaller shops lack the variety of inventory required for the children, and the larger shops quickly offload discontinued lines. However, by arranging to share inventory between a large shop and a small shop, the customer's purchase experience is streamlined and improved. Arrangements between retailers to collaborate for the customer's benefit can include splitting returns, fixed fees, ongoing agreements to supply one another, transfer of inventory not related to the immediate sale, and others. Other arrangements and collaborative techniques will be appreciated in view of the disclosures herein.

In some embodiments, rules can be implemented to control whether inventory is “shared” automatically or requires approval. In some embodiments, a retailer can automatically be notified that items in the retailer's inventory can be used to fulfill another retailer's shortfall. In some embodiments, a retailer with an inventory shortfall can be notified of retailers that can reconcile the shortfall. In either case, the retailers can propose deals and accept or reject opportunities to share. Two-way notification can occur in some embodiments, permitting a variety of retailers with shortfalls or surpluses to offer to others who can have or need a particular inventory. In other embodiments, participation in the system mandates sharing subject to predetermined arrangements.

In some embodiments, rules can be implemented to adjust pricing real-time. The rate of change of inventories, sales trends, and queries related to a particular item, success or failure of competitors, announcement or introduction of competitors, and other factors can influence the pricing of an inventory. In some aspects, retailers and customers can have different prices set. For example, a retailer seeking to fulfill a customer order can receive a discounted price from another retailer, contrasted with a customer ordering directly from the retailer, who would receive a different discount (or none at all). For example, if master inventory 104 indicates only one retailer has remaining stock of a particular model of ski pole, the retailer can be notified, or pricing can automatically adjust upwards, to set pricing according to the current level of supply and demand.

System 100 can also facilitate competition between retailers. For example, a customer can provide a bid using customer interface component 108 for an item in master inventory 104. Retailers can attempt to meet or undercut the bid for the customer's business. In some embodiments, a customer order can be held for a length of time to allow other retailers to provide a better deal. Retailers can also provide coupons, discounts, or other incentivizing offers via customer interface component 108.

In some embodiments, system 100 can be nested within other layers of analogous systems. For example, master inventory 104 can relate to a particular niche, but in addition to functioning as a free-standing integrated inventory, a higher level inventory or directory can index or contain a pointer to master inventory 104. The higher level inventory or directory can be related but lack the specificity of master inventory 104. In one example, master inventory 104 can be a car tire inventory from a variety of retailers who sell car tires. Such retailers can be dedicated tire stores, mechanic's shops, general auto parts stores, tire manufacturers, and car dealers. Master inventory 104 can also be linked to a directory generally related to cars as well. By nesting, embedding or linking embodiments of system 100 within other embodiments of analogous systems, collaborative and competitive behaviors benefitting retailers and customers, such as direct linking to higher-level inventories (e.g. manufacturers or distributors) can be effected. This also expedites the customer shopping process by allowing them to jump between specific search regions faster. However, this arrangement need not be accomplished in all embodiments. In some embodiments, system 100 is independent, where retailer interface component 106, customer interface component 108, and other associated components are focused specifically on a single niche market (e.g., skis) and do not nest or associate with generalized levels of products (e.g., sporting goods). In some embodiments, system 100 can sync with a physical store. For example, a retailer's inventory can be housed, in whole or in part, at a physical store location. Retailer interface component 106 can interact with sales distribution component 110 and inventory integration component 102 to update master inventory 104 with the details of in-store sales. In an embodiment, retailer interface component 106 includes customer interface component 108 that allows a store-based retailer to query master inventory 104 and execute an in-store sale similarly to an online sale. In some embodiment, a kiosk can be provided in-store that includes customer interface component 108, allowing in-store customers to access master inventory 104 to access expanded inventories or comparison shop. In some such embodiments, customer interface component 108 on a kiosk is modified to support the store, masking the source of some or all of master inventory 104. Items immediately available in-store can be indicated via the kiosk, but competing retailer's items and other inventory not locally in-stock can be shown according to the price and time that they can reach the store location. In some embodiments, customer interface component 108 can calculate alternatives in-store (e.g., comparing costs shipped-to-store and shipped-to-home, tax rates in-store versus online).

In some embodiments, sales distribution component 110 can employ radio-frequency identification tags (RFID tags) or other electronic tracking mechanisms to control information to master inventory 104. For example, if an inventory is transferred between warehouses, information about the inventory and its location can be updated to master inventory 104. RFID tags can be employed with inventory integration component 102 to track incoming or outgoing shipments from an inventory location (e.g., physical store, warehouse) that were not entered through retailer interface component. In an embodiment, an audit can be conducted on master inventory 104 via RFID tags to confirm the accuracy of master inventory 104′s information. Techniques and technologies alternative to RFIDs that accomplish the same result will be appreciated by those skilled in the art in view of the disclosures herein.

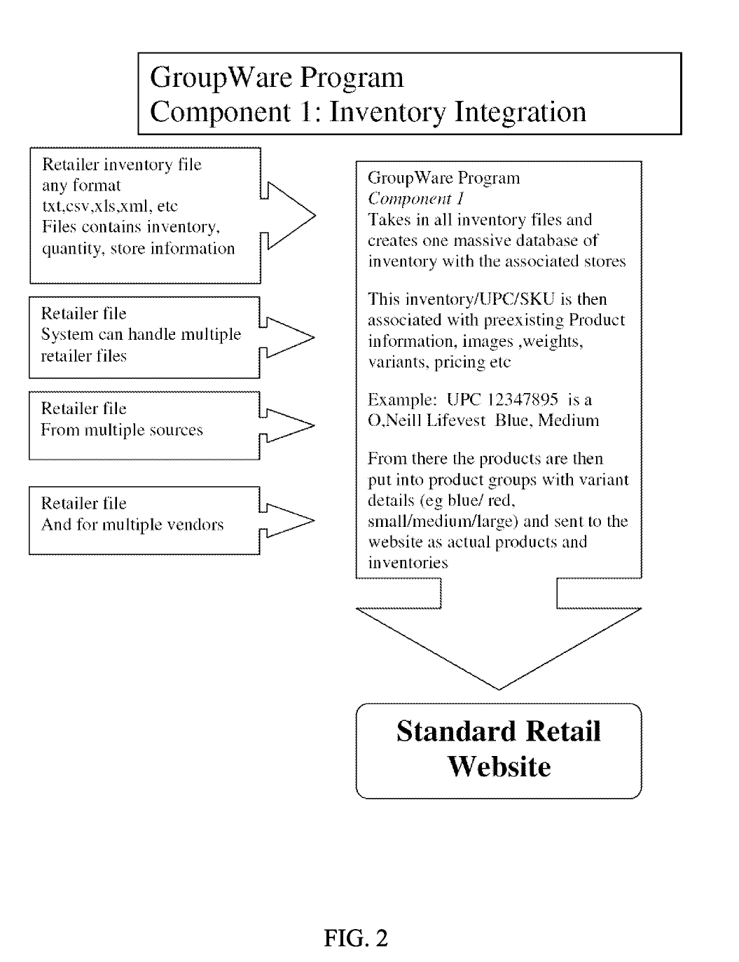

FIG. 2 illustrates example aspects of an inventory integration component in aspects of the subject innovation. For example, an inventory integration component can receive inventory information from one or more retailers, such as in any of a variety of file formats (e.g., .txt, .csv, .xls, .xml, relational databases such as .sql, etc.). These files can contain a variety of information related to the inventories of the one or more retailers, such as product identification information (e.g., UPC, SKU, etc.), quantity information, store information, etc. In some aspects, location information can be received by the inventory integration component in some or all of the one or more inventory files, identifying a location associated with some or all of the products listed in the inventory file (e.g., when a retailer has more than one location, etc.). In other aspects, location information can be determined by an inventory integration component (e.g., when a retailer has a single location, etc.) and associated with the product information in a common or master database, such as master database 104. An inventory integration component of the subject innovation (e.g., inventory integration component 102) can aggregate inventory information from multiple files, from multiple sources, and from multiple vendors or retailers.

As seen in FIG. 2, this inventory information (e.g., identifying products in a retailer's inventory along with quantity and store information, etc.) can be associated with pre-existing product information, such as images, dimensions, weights, variations (e.g., color, style, size, etc.), pricing, etc. The product and inventory information in or to be put in a common or master database can be organized into product groups, with variations of similar items grouped together (e.g., different colored or sized versions of an item, etc.). This information can then be provided to a customer through one or more interfaces (e.g., web page, mobile application, etc.). In the example of FIG. 2, the interface is a retail website.

The inventory integration can occur initially, to create a common or master inventory (for example, as a database (e.g., relational, etc.), etc.), and can also occur periodically or intermittently, for example as inventories change (e.g., through a customer interface of the subject innovation, through re-stocking or the addition of newly stocked items, through retail sales (e.g., at a brick-and-mortar store, etc.) of inventory items, etc.).

In some aspects, inventory integration component can monitor trends or determine sales information (e.g., based on changes in the one or more inventories, etc.) associated with the aggregate inventory of the one or more retailers and provide associated information to the one or more retailers. This information can be based on substantially any of the information stored in the common or master inventory, alone or in combination (e.g., indicating demand for products, purchases associated with locations, over time, etc.). This information can be useful in making decisions related to inventory, marketing, etc.

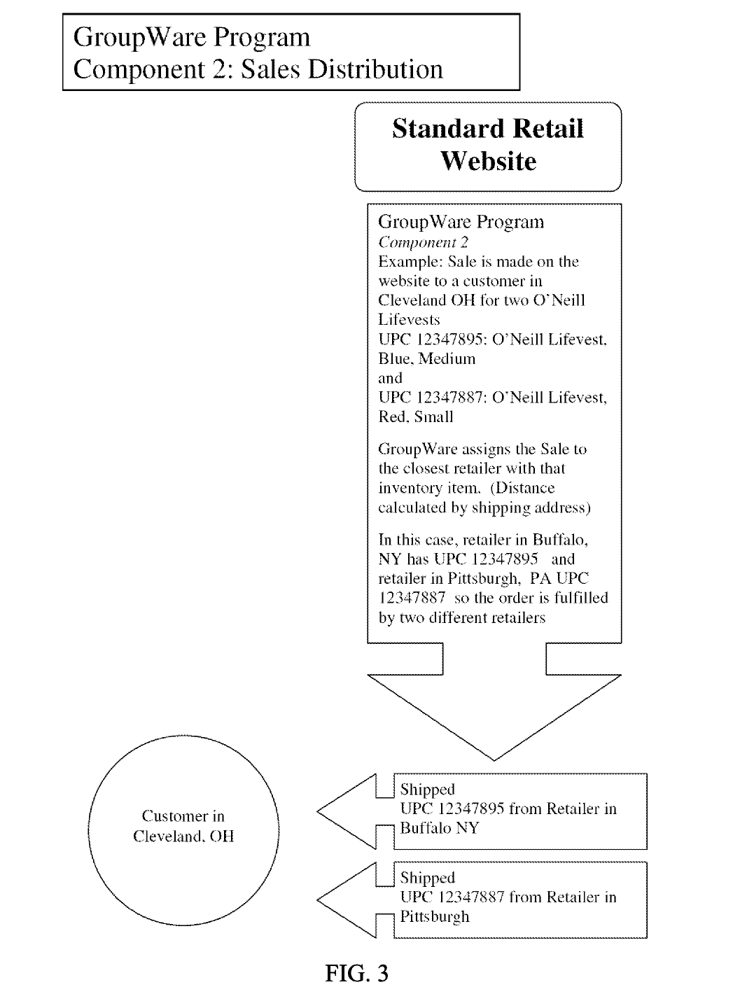

FIG. 3 illustrates an example implementation of a sales distribution component in accordance with aspects of the subject innovation. As seen in FIG. 3, a customer can purchase one or more products through a customer interface (e.g., the retail website of FIG. 3, etc.). A sales distribution component of an embodiment of the subject innovation (e.g., the GroupWare Program in FIG. 3, etc.) can determine an appropriate retailer to ship each product of the order. For example, for each of the one or more products, the sales distribution component can determine a closest retailer as the appropriate retailer (e.g., as determined by a distance between the retailer and the shipping address). In other aspects, the appropriate retailer can be determined in other ways, such as shortest shipping time to deliver the product, the retailer with the closest product (e.g., if a first store of retailer A is the closest store but retailer A only has the product at a second store farther away than retailer B has the product, retailer B may be more appropriate, etc.), or in other ways. In some aspects, a customer can select the method, which can be based on one or more characteristics (e.g., the closest retailer which meets a selected minimum feedback rating, etc.).

Next, the appropriate retailer can be contacted to fulfill the order, for example through a retailer interface component. If for some reason, the appropriate retailer is unable to fulfill the order or unable to fulfill the order subject to certain constraints (e.g., delivery by a certain time, etc.), a next most appropriate retailer can be selected among the remaining retailers in any of the manners described herein. The retailer interface component can serve additional purposes, as well, such as providing payment to the retailer for a product from an entity managing a system of the subject innovation.

In the example of FIG. 3, each of the two products was assigned to a different retailer based on being the closest retailer to stock the item in question. The appropriate retailer for each product can then ship each product to the customer.

The customer interface component can serve as an Internet store, and incorporate features of such a store into the subject innovation. For example, feedback related to products or the shipment thereof can be related by customers through the customer interface component, and if relevant, provided to the appropriate retailer. In aspects, if a retailer consistently receives negative reviews that may impact sales of other retailers through a system of the subject innovation, the negatively reviewed retailer can be disassociated from the system. In another example, billing and shipping information can be entered for the customer for all purchases made through a system of the subject innovation, regardless of the individual retailers that may end up providing the items.

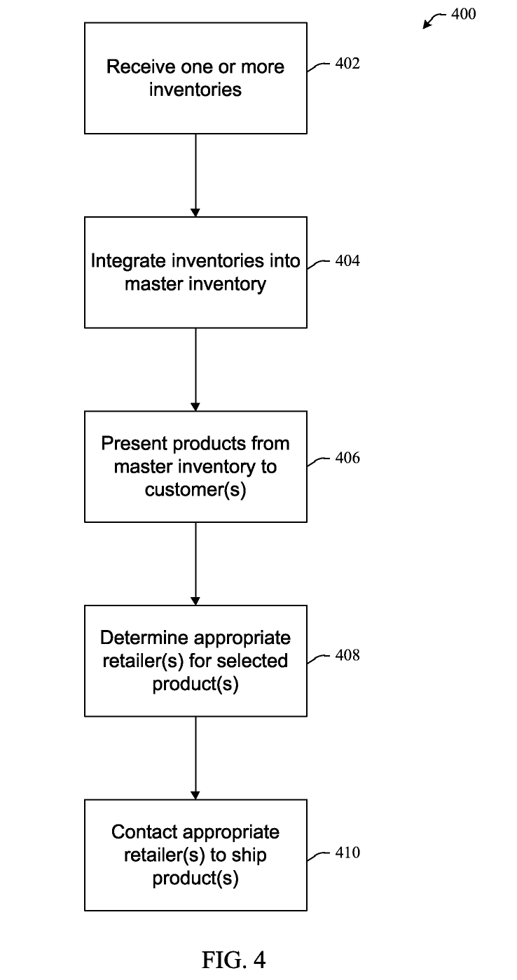

Turning to FIG. 4, shown is a flowchart of a method 400 of selling one or more products in accordance with aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Method 400 can begin at step 402, wherein information associated with one or more inventories can be received, such as one from each of one or more retailers, or more than one from some retailers (e.g., one per store, etc.). This inventory information can be integrated into a master or common inventory at step 404, providing a total inventory of all products from the one or more retailers. Integrating the inventories can include other acts as described herein, such as taking information presented in disparate data formats and reorganizing the information into a common format, and associating location information with products in the master inventory. At step 406, the products from the master inventory can be presented to customers through an interface such as a retail website or mobile application. At step 408, in response to a customer selecting one or more products, for each product, an appropriate retailer of the one or more retailers can be determined (e.g., the closest retailer, etc.). Then, at step 410, the appropriate retailer for each product can be contacted or notified of the order, so that the retailer can complete the order and ship the product.

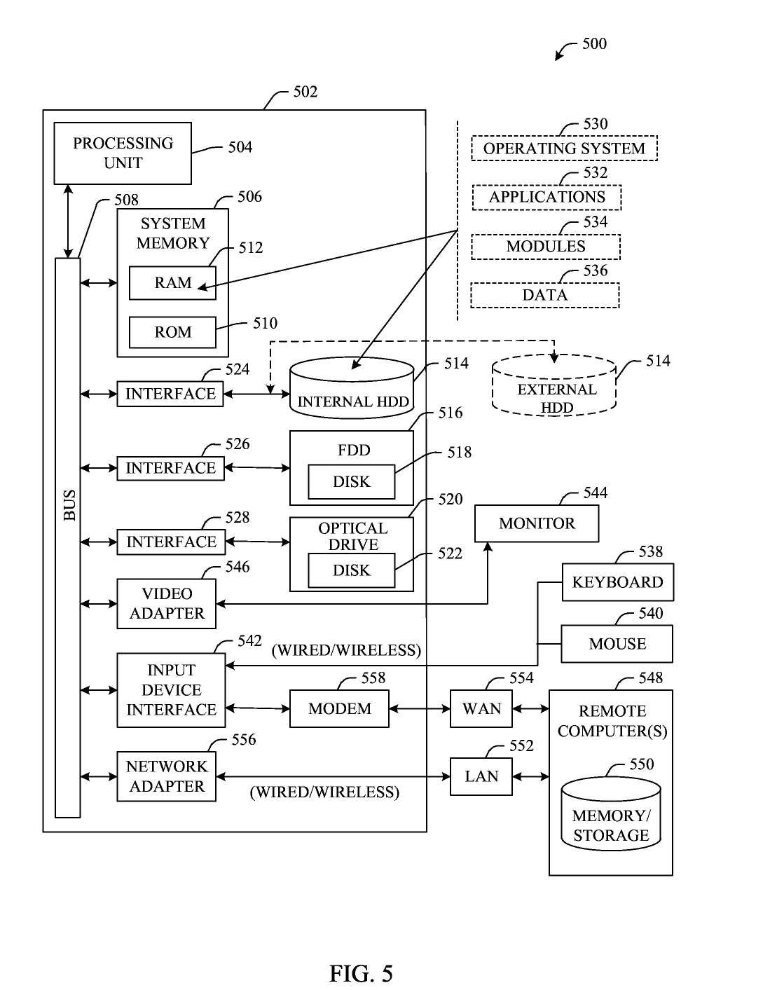

Referring now to FIG. 5, there is illustrated a block diagram of a computer operable to execute the disclosed architecture. In order to provide additional context for various aspects of the subject innovation, FIG. 5 and the following discussion are intended to provide a brief, general description of a suitable computing environment 500 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 5, the exemplary environment 500 for implementing various aspects of the innovation includes a computer 502, the computer 502 including a processing unit 504, a system memory 506 and a system bus 508. The system bus 508 couples system components including, but not limited to, the system memory 506 to the processing unit 504. The processing unit 504 can be any of various commercially available processors. Dual microprocessors and other multi-processor architectures may also be employed as the processing unit 504.

The system bus 508 can be any of several types of bus structure that may further interconnect to a memory bus (with or without a memory controller), a peripheral bus, and a local bus using any of a variety of commercially available bus architectures. The system memory 506 includes read-only memory (ROM) 510 and random access memory (RAM) 512. A basic input/output system (BIOS) is stored in a non-volatile memory 510 such as ROM, EPROM, EEPROM, which BIOS contains the basic routines that help to transfer information between elements within the computer 502, such as during start-up. The RAM 512 can also include a high-speed RAM such as static RAM for caching data.

The computer 502 further includes an internal hard disk drive (HDD) 514 (e.g., EIDE, SATA), which internal hard disk drive 514 may also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high capacity optical media such as the DVD). The hard disk drive 514, magnetic disk drive 516 and optical disk drive 520 can be connected to the system bus 508 by a hard disk drive interface 524, a magnetic disk drive interface 526 and an optical drive interface 528, respectively. The interface 524 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 512, including an operating system 530, one or more application programs 532, other program modules 534 and program data 536. All or portions of the operating system, applications, modules, and/or data can also be cached in the RAM 512. It is appreciated that the innovation can be implemented with various commercially available operating systems or combinations of operating systems.

A user can enter commands and information into the computer 502 through one or more wired/wireless input devices, e.g., a keyboard 538 and a pointing device, such as a mouse 540. Other input devices (not shown) may include a microphone, an IR remote control, a joystick, a game pad, a stylus pen, touch screen, or the like. These and other input devices are often connected to the processing unit 504 through an input device interface 542 that is coupled to the system bus 508, but can be connected by other interfaces, such as a parallel port, an IEEE 1394 serial port, a game port, a USB port, an IR interface, etc.

A monitor 544 or other type of display device is also connected to the system bus 508 via an interface, such as a video adapter 546. In addition to the monitor 544, a computer typically includes other peripheral output devices (not shown), such as speakers, printers, etc.

The computer 502 may operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which may connect to a global communications network, e.g., the Internet.

When used in a LAN networking environment, the computer 502 is connected to the local network 552 through a wired and/or wireless communication network interface or adapter 556. The adapter 556 may facilitate wired or wireless communication to the LAN 552, which may also include a wireless access point disposed thereon for communicating with the wireless adapter 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wired or wireless device, is connected to the system bus 508 via the serial port interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

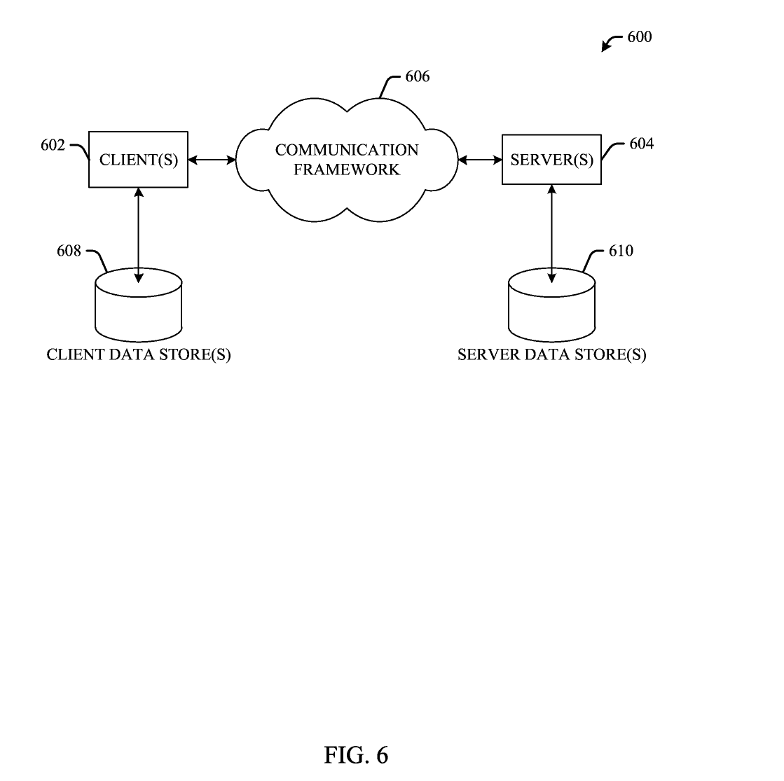

Referring now to FIG. 6, there is illustrated a schematic block diagram of an exemplary computing environment 600 in accordance with the subject innovation. The system 600 includes one or more client(s) 602. The client(s) 602 can be hardware and/or software (e.g., threads, processes, computing devices). The client(s) 602 can house cookie(s) and/or associated contextual information by employing the innovation, for example.

The system 600 also includes one or more server(s) 604. The server(s) 604 can also be hardware and/or software (e.g., threads, processes, computing devices). The servers 604 can house threads to perform transformations by employing the innovation, for example. One possible communication between a client 602 and a server 604 can be in the form of a data packet adapted to be transmitted between two or more computer processes. The data packet may include a cookie and/or associated contextual information, for example. The system 600 includes a communication framework 606 (e.g., a global communication network such as the Internet) that can be employed to facilitate communications between the client(s) 602 and the server(s) 604.

Communications can be facilitated via a wired (including optical fiber) and/or wireless technology. The client(s) 602 are operatively connected to one or more client data store(s) 608 that can be employed to store information local to the client(s) 602 (e.g., cookie(s) and/or associated contextual information). Similarly, the server(s) 604 are operatively connected to one or more server data store(s) 610 that can be employed to store information local to the servers 604.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates selling one or more products, comprising:
a tangible computer readable medium including processor-executable instructions for:
an inventory integration component that receives information related to one or more inventories associated with one or more retailers and creates a master inventory including at least the information related to the one or more inventories; and
a customer interface component that presents data regarding the one or more products for sale to a customer, wherein the customer information component obtains the data from the master inventory.

2. The system of claim 1, further comprising a sales distribution component that determines, from the one or more retailers, an appropriate retailer for each of the one or more products upon selection of the one or more products by the customer.

3. The system of claim 2, wherein the appropriate retailer for each of the one or more products is contacted to ship each of the one or more products to the customer.

4. The system of claim 2, wherein the appropriate retailer for each of the one or more products is determined based on being a closest retailer to a shipping address of the customer, among a subset of the one or more retailers that stock each product.

5. The system of claim 2, wherein the sales distribution component updates the master inventory in response to selection of the one or more products by the customer.

6. The system of claim 1, further comprising a retailer interface component that contacts the appropriate retailer for each of the one or more products.

7. The system of claim 6, wherein the retailer interface component includes a communication module that delivers messages between the one or more retailers.

8. A method that facilitates selling one or more products, comprising:
executing the following steps at least in part utilizing a tangible computer readable medium operatively coupled to a processing unit:
receiving data associated with one or more inventories of one or more retailers;
integrating the data into a master inventory that associates the one or more inventories with the one or more retailers; and
presenting the one or more products to a customer based at least in part on information stored in the master inventory.

9. The method of claim 8, further comprising determining an appropriate retailer for each product of the one or more products.

10. The method of claim 9, further comprising providing shipping information to the appropriate retailer for each product upon selection of each product by the customer.

11. The method of claim 9, wherein determining the appropriate retailer for each product comprises determining a closest retailer to a shipping address of the customer from a subset of the one or more retailers, wherein the subset comprises retailers with each product in stock.

12. The method of claim 9, further comprising notifying two or more retailers of an order including two or more products being fulfilled by the two or more retailers.

13. The method of claim 8, further comprising placing a bulk inventory order, wherein at least two portions of the bulk inventory order are associated with at least two or more inventories of two or more retailers.

14. The method of claim 8, further comprising tracking at least one element of the master inventory.

15. The method of claim 14, wherein tracking is accomplished at least in part using RFID tags.

16. The method of claim 8, wherein presenting the one or more products to the customer includes unique information about one or more individual elements from the master inventory.

17. The method of claim 8, wherein presenting the one or more products to the customer includes an incentive from at least one of the one or more retailers.

18. The method of claim 8, wherein presenting the one or more products to the customer includes presenting an alternative product from the master inventory.

19. The method of claim 8, wherein presenting the one or more products to the customer includes presenting at least two options related to the one or more products from the one or more retailers.

20. A system, comprising:
means for creating a master inventory from one or more business inventories of one or more retailers;
means for offering at least one product from the master inventory for a sale to a customer;
means for completing the sale of the at least one product from the master inventory;
means for determining a shipping retailer to ship the at least one product from among the one or more retailers;
means for updating the master inventory in response to the sale; and
means for replenishing the one or more business inventories in response to the sale.
